(19) United States
(12) Patent Application Publication
(10) Pub. No.: US 2014/0289454 A1
(43) Pub. Date: Sep. 25, 2014

(54) STORAGE DEVICE AND CONTROLLER

(71) Applicant: KABUSHIKI KAISHA TOSHIBA, Tokyo (JP)

(72) Inventors: Takahiro NANGO, Tokyo (JP); Kiyotaka IWASAKI, Kanagawa (JP); Hiroyuki MORO, Tokyo (JP)

(73) Assignee: KABUSHIKI KAISHA TOSHIBA, Tokyo (JP)

(21) Appl. No.: 14/016,001

(22) Filed: Aug. 30, 2013

Related U.S. Application Data
(60) Provisional application No. 61/804,085, filed on Mar. 21, 2013.

(51) Int. Cl. G06F 12/02; G06F 3/06

(52) U.S. Cl. CPC G06F 12/0246; G06F 3/0644; G06F 3/0679; G06F 3/0608
USPC 711/103; 711/153

(57) ABSTRACT

A storage device includes a memory having one or more storage regions each of which is assigned a physical address, and a controller having a writing control circuit configured to write data that is divided into a plurality of data units into logical storage positions, at least one of which is associated with two storage regions of the memory, and a conversion unit configured to perform a conversion process on a logical address of the logical storage position that is associated with two storage regions of the memory to generate physical addresses corresponding to the two storage regions of the memory.

### CROSS-REFERENCE TO RELATED APPLICATION

This application is based upon and claims the benefit of priority from U.S. Provisional Patent Application No. 61/804,085, filed Mar. 21, 2013, the entire contents of which are incorporated herein by reference.

### FIELD

Exemplary embodiments described herein relate to a storage device and a controller.

### BACKGROUND

A NAND type flash memory, in which data is electrically writable and erasable, is used as a nonvolatile memory for a storage device or a memory system. In the NAND type flash memory, a physical address is associated with a page which is set as a single control unit for reading and writing.

A host manages data stored in a flash memory by using a logical address. When data transfer is performed between the host and the flash memory, a conversion process is performed on the logical address, and then data from the host is written into the flash memory at the physical address converted from the logical address.

### DESCRIPTION OF THE DRAWINGS

FIG. 1 is a diagram illustrating an overall configuration of a storage device according to an exemplary embodiment.

FIG. 2 is a diagram schematically illustrating an internal configuration of the storage device of the exemplary embodiment.

FIG. 3 is a diagram schematically illustrating an internal configuration of a flash memory.

FIG. 4 is a diagram illustrating an internal configuration example of a memory cell array of the flash memory.

FIG. 5 is a diagram illustrating an example of the relationship between physical address and data.

FIG. 6 is a diagram illustrating another example of the relationship between physical address and data.

FIG. 7 is a diagram illustrating an operation of the storage device of the exemplary embodiment.

FIG. 8 is a diagram illustrating another operation of the storage device of the exemplary embodiment.

FIG. 9 is a diagram illustrating an example of the relationship between logical address and physical address.

FIG. 10 is a diagram illustrating another example of the relationship between logical address and physical address.

FIG. 11 is a diagram illustrating an example of an address management table.

FIG. 12 is a diagram illustrating an example of an address conversion process in the storage device of the exemplary embodiment.

FIG. 13 is a diagram illustrating another example of the address conversion process in the storage device of the exemplary embodiment.

FIG. 14 is a diagram illustrating another example of the address conversion process in the storage device of the exemplary embodiment.

FIG. 15 is a diagram illustrating an operation example of the storage device of the exemplary embodiment.

FIG. 16 is a diagram illustrating an operation example of the storage device of the exemplary embodiment.

FIG. 17 is a diagram illustrating a modified example of the storage device of the exemplary embodiment.

FIG. 18 is a diagram illustrating an application example of the storage device of the exemplary embodiment.

FIG. 19 is a diagram illustrating an application example of the storage device of the exemplary embodiment.

FIG. 20 is a diagram illustrating another application example of the storage device of the exemplary embodiment.

### DETAILED DESCRIPTION

Hereinafter, with reference to the drawings, the exemplary embodiment will be described in detail.

In the following description, an element having the same function and configuration is given the same reference numeral, and the description thereof is made as necessary.

In general, according to one embodiment, a storage device includes a memory having one or more storage regions each of which is assigned a physical address, and a controller having a writing control circuit configured to write data that is divided into a plurality of data units into logical storage positions, at least one of which is associated with two storage regions of the memory, and a conversion unit configured to perform a conversion process on a logical address of the logical storage position that is associated with two storage regions of the memory to generate physical addresses corresponding to the two storage regions of the memory.

### (1) Exemplary Embodiment

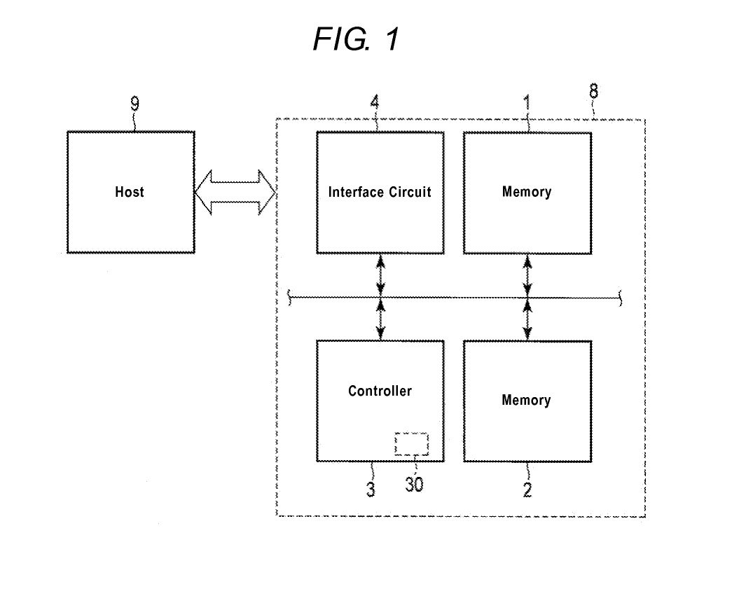

With reference to FIG. 1 to FIG. 9, a storage device of the exemplary embodiment will be described.

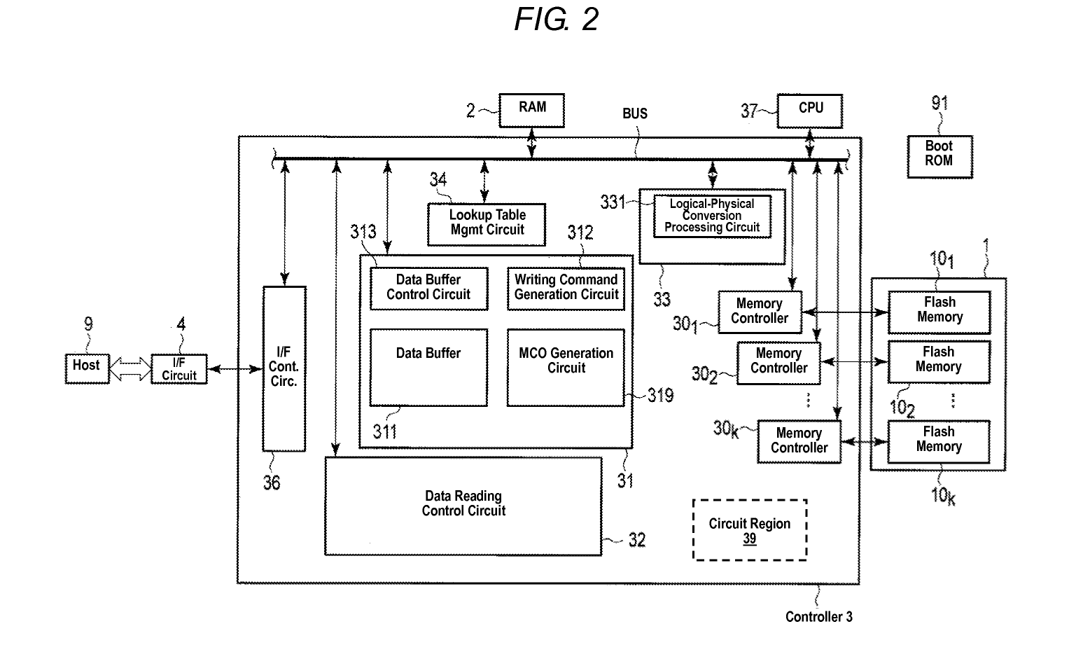

FIG. 1 is a block diagram schematically illustrating main portions of the storage device of the exemplary embodiment. FIG. 2 is a schematic block diagram illustrating an example of an internal configuration of a controller of the storage device of the exemplary embodiment.

As shown in FIG. 1, the storage device 8 of the exemplary embodiment includes a first memory 1, a second memory 2, a controller (hereinafter, also referred to as a processor) 3, an interface circuit 4, and the like.

The memories 1 and 2, the controller 3, and the interface circuit 4 are connected to each other via a bus, and can transmit and receive data and signals to and from each other.

For example, the storage device 8 is a solid state drive (SSD).

The first memory 1 stores data which is transmitted from a host 9 or other devices, or data which is generated in the storage device 8. A nonvolatile memory is used as the first memory 1. For example, as shown in FIG. 2, the first memory 1 includes one or more flash memories 10₁, 10₂, and 10ₖ. Hereinafter, if the flash memories are not differentiated from each other, the flash memories are referred to as flash memory 10 or flash memories 10.

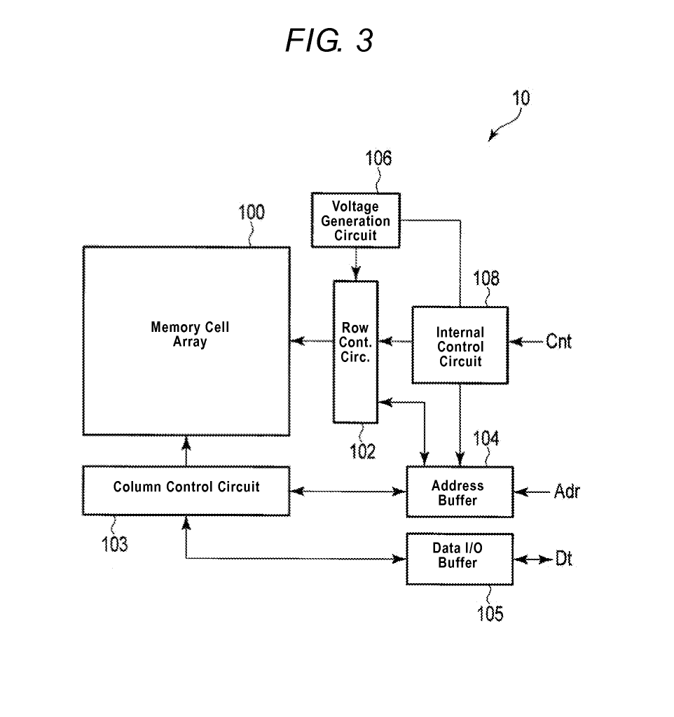

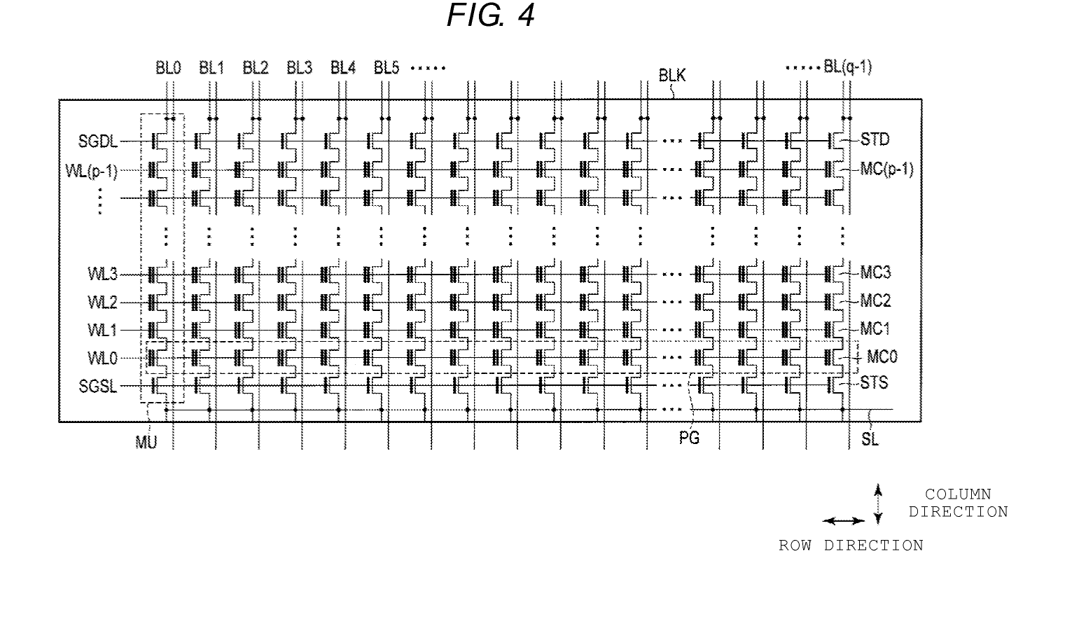

With reference to FIGS. 3 and 4, a configuration example of the flash memory 10 which is the first memory will be described.

FIG. 3 is a block diagram illustrating main portions of an internal configuration of the flash memory.

As shown in FIG. 3, the flash memory 10 includes a memory cell array 100 storing data. The memory cell array 100 includes a plurality of memory cells.

If the flash memory 10 used for the first memory 1 is, for example, a NAND type flash memory, the memory cell array 100 includes a plurality of blocks. A block represents the minimum erasure unit.

FIG. 4 is an equivalent circuit diagram illustrating an internal configuration of the memory cell array 100. FIG. 4 shows a single block circuit configuration of the memory cell array 100 of the NAND type flash memory 10.

In the NAND type flash memory 10, a single block includes a plurality of memory cell units (hereinafter, also referred to as NAND cell units) MU arranged in a row direction. For example, q memory cell units MU are provided in a single block.

A single memory cell unit MU includes a memory cell string having a plurality of (for example, p) memory cells MC0 to MC(p−1), a first select transistor STS (hereinafter, referred to as a source side select transistor) which is connected to one end of the memory cell string, and a second select transistor STD (hereinafter, referred to as a drain side select transistor) which is connected to the other end of the memory cell string. In the memory cell string, current paths of the memory cells MC0 to MC (p−1) are connected in series in a column direction. The number of the memory cells forming a single memory cell unit MU may be two or more. Hereinafter, if the memory cells MC0 to MC(p−1) are not differentiated from each other, the memory cells are referred to as a memory cell MC or memory cells MC.

One end (source side) of the memory cell unit MU, more specifically, one end of the current path of the source side select transistor STS is connected to a source line SL. In addition, the other end (drain side) of the memory cell unit MU, that is, one end of the current path of the drain side select transistor STD is connected to a bit line BL.

The memory cell MC is a field effect transistor with a gate structure having a charge accumulation layer (for example, a floating gate electrode, or an insulating film including a trap level). In the two adjacent memory cells MC in the column direction, the source of one memory cell MC is connected to the drain of the other memory cell MC. Thereby, the current paths of the memory cells MC adjacent to each other are connected in series to form the memory cell string.

The drain of the source side select transistor STS is connected to the source of the memory cell MC0. The source of the source side select transistor STS is connected to the source line SL. A voltage of the source line SL is controlled by a source line control circuit (not shown).

The source of the drain side select transistor STD is connected to the drain of the memory cell MC(p−1). The drain of the drain side select transistor STD is connected to one of a plurality of bit lines BL0 to BL(q−1).

Word lines WL0 to WL(p−1) extend in the row direction, and each of the word lines WL0 to WL (p−1) is connected in common to the gates of a plurality of memory cells MC arranged in the row direction.

A drain side select gate line SGDL extends in the row direction, and is connected in common to the gates of a plurality of drain side select transistors STD arranged in the row direction. A source side select gate line SGSL extends in the row direction, and is connected in common to the gates of a plurality of source side select transistors STS arranged in the row direction.

Hereinafter, if the bit lines BL0 to BL(q−1) are not differentiated from each other, the bit lines are referred to as a bit line BL or bit lines BL, and if the word lines WL0 to WL(p−1) are not differentiated from each other, the word lines are referred to as a word line WL or word lines WL.

Each memory cell MC stores data from outside by setting a magnitude of a threshold voltage (distribution of threshold voltage) of the memory cell (transistor) MC according to the data.

Each memory cell MC stores binary (1 bit) or ternary (2 bits) or more data.

For example, if a single memory cell MC stores binary (1 bit) data “0” and “1”, the memory cell MC has two threshold distributions corresponding to the data. In addition, if a single memory cell MC stores quaternary (2 bits) data “00”, “01”, “10” and “11”, the memory cell MC has four threshold distributions corresponding to the data. Hereinafter, a memory cell which stores ternary (2 bits) or more data is referred to as a multi-value memory.

Data is collectively written in or read from the memory cells MC connected to the same word line WL. The control unit of writing or reading of data in the flash memory is called a page (or a physical page) PG. Data of the multi-value memory is written and read for each lower bit or for each higher bit. Therefore, if the single memory cell MC holds 2-bit data, two pages are assigned to a single word line WL.

A storage capacity (data size) of the page which is a storage region is defined by the number of the memory cells MC connected to the word line WL.

Here, in the NAND type flash memory, the unit of a data size which can be accessed at one time is called a cluster. In the exemplary embodiment, data with a size corresponding to a cluster is referred to as cluster data. A single cluster includes a plurality of sectors. Data with a size corresponding to a sector is referred to as sector data. The cluster data includes an error correction code added to the data.

A row control circuit 102 controls the rows of the memory cell array 100. The row control circuit 102 is connected to the word lines WL and the select gate lines SGDL and SGSL provided in the memory cell array 100. The row control circuit 102 includes a row decoder, a word line driver, and the like. The row control circuit 102 selects a block and a page on the basis of an address signal Adr transferred from an address buffer 104, and controls operations (voltages) of the word lines WL and the select gate lines SGDL and SGSL.

A column control circuit 103 controls selection and voltages of the bit lines BL of the memory cell array 100, input and output of data read from the memory cell MC, input and output of data written in the memory cell MC, and the like. The column control circuit 103 includes a sense amplifier circuit, a data latch circuit, a column decoder, and the like. The sense amplifier circuit detects and amplifies a voltage variation of the bit line BL when data is read (when data is output from the memory cell array 100), and discriminates data which is stored in the memory cell MC. The sense amplifier circuit charges or discharges the bit line BL when data is written (when data is input to the memory cell array 100). The data latch circuit temporarily stores data read from the memory cell array 100 and data which is to be written in the memory cell array 100. The column decoder selects and activates a control unit which is set for a column of the memory cell array 100.

A voltage generation circuit 106 generates a writing voltage, a reading voltage, an erasing voltage, an intermediate voltage, and a non-selection voltage, which are respectively applied to each word line WL when data is written (programmed), and data is read and erased. In addition, the voltage generation circuit 106 generates, for example, a voltage applied to the select gate lines SGDL and SGSL. The voltages generated by the voltage generation circuit 106 are input to the row control circuit 102 and are respectively applied to a selected word line, a non-selected word line, and the select gate lines. The voltage generation circuit 106 generates a voltage applied to the source line SL and a voltage applied to a well region.

A data input and output buffer 105 is an interface of input and output of data in the flash memory 10. The data input and output buffer 105 temporarily holds data Dt from an external device (for example, the controller, the host, or the like). The data input and output buffer 105 outputs the held data from the external device to the memory cell array 100 at a predetermined timing. The data input and output buffer 105 temporarily holds data which is output from the memory cell array 100. The data input and output buffer 105 outputs the held data Dt to an external device of the flash memory 10 at a predetermined timing.

The address buffer 104 temporarily holds an input address signal Adr. The input address signal Adr indicates a physical address in the flash memory, and includes a physical row address and a physical column address.

An internal control circuit (also referred to as a state machine) 108 manages an operation of the overall flash memory.

The internal control circuit 108 receives a control signal (command) Cnt from an external device. The control signal Cnt is output from, for example, a controller 3 or the host 9. For example, the internal control circuit 108 includes a command interface and the like. For example, the internal control circuit 108 transmits a control signal (status) indicating internal operation circumstances of the flash memory 10 to the controller 3 (or the host). Thereby, a notification of the operation circumstances of the flash memory 10 is sent to the external controller 3 or host 9 of the flash memory 10.

The second memory 2 is, for example, a RAM. The RAM which is the second memory 2 temporarily holds a management table of the flash memory 10 which is the first memory 1, or data transferred between the host 9 and the first memory 1. The RAM 2 which is the second memory 2 includes at least one of an SRAM, a DRAM, an MRAM, a ReRAM and a PCRAM.

An interface circuit (also referred to as a host interface circuit) 4 controls communication (data transfer, or input and output of a signal) between the storage device 8 and the host 9. The interface circuit 4 includes an interface (also referred to as a host interface) controlling data transfer between the storage device 8 and the host 9 on the basis of a standard such as SAS or SATA.

The host 9 transmits (issues) various commands or requests to the storage device 8 according to an operation executed by the host 9. The host 9 transmits data which should be written to the memory 1 to the storage device 8, or receives data which is read from the memory 1, from the storage device 8.

The controller 3 manages and controls operations of the respective circuits 1, 2 and 4 in the storage device 8 in response to commands and requests from the host 9.

As shown in FIG. 2, the controller 3 is connected to the RAM 2, a CPU 37, a boot ROM 91, and the like in the storage device 8.

The CPU 37 performs data transfer between the storage device 8 and the host 9, and performs a variety of operations for internal processes of the storage device 8. In addition, the CPU 37 may analyze a command or a request from the host 9. The CPU 37 can control and manage of each circuit of the controller 3.

The boot ROM 91 includes a program for booting a management program stored in the flash memory 10.

The RAM 2 temporarily holds data from the host 9, and transmits the data to the controller 3. In addition, the RAM 2 receives data which is transmitted from the flash memory 1 to the RAM 2 via the controller 3 such that the data is temporarily held in the storage device 8 during a period until data from the memory 1 and memory controllers 30₁, 30₂ and 30ₖ is transferred to the host 9.

As shown in FIG. 2, the controller 3 included in the storage device 8 of the exemplary embodiment includes an interface control circuit 36, a data writing control circuit 31, a data reading control circuit 32, a command management circuit 33, a lookup table management circuit 34, and the memory controllers 30₁, 30₂ and 30ₖ.

The interface control circuit (also referred to as a host interface control circuit) 36 manages and controls an operation of the interface circuit 4 which enables communication between the storage device 8 and the host 9 to be performed. The interface control circuit 36 may be provided in the interface circuit 4.

The memory controllers 30₁, 30₂ and 30ₖ manage and control operations of writing, reading, and erasing data with respect to the flash memory which is the first memory 1. For example, a plurality of memory controllers 30₁, 30₂ and 30ₖ are provided in the controller 3 according to the number of a plurality of flash memories 10₁, 10₂, and 10ₖ included in the first memory 1. For example, one or more memory controllers 30₁, 30₂ and 30ₖ are provided in the controller 3 such that the flash memory 10 and the memory controller 30 correspond to each other in a one-to-one relationship.

Hereinafter, if the memory controllers 30₁, 30₂ and 30ₖ are not differentiated from each other, the memory controllers are referred to as a memory controller 30 or memory controllers 30. In FIG. 2, k memory controllers 30 and k NAND type flash memories 10 are provided, and the number of channels formed between the first memory 1 and the memory controllers 30 is k. However, the number of channels formed between the first memory 1 and the memory controllers 30 may be one. If the flash memory 10 is a NAND type flash memory as in the exemplary embodiment, the memory controller 30 is also referred to as a NAND controller 30.

The data writing control circuit (WC) 31 performs control for transferring data from the host 9 to the memory controller 30 and the flash memory 10, or a variety of internal processes for writing data, when the data is written to the flash memory 10.

The data writing control circuit 31 includes a data buffer 311, a buffer control circuit 313, and a writing command generation circuit 312.

The data buffer 311 temporarily holds data which should be written to the flash memory 10 before the data is transferred to the memory controller 30 and the flash memory 10. In addition, the RAM 2 may be used for the data buffer 311.

The buffer control circuit 313 controls an operation of the data buffer, for example, a timing when data is transferred from the data buffer 311 to the memory controller 30.

The writing command generation circuit 312 generates various commands used for writing data to the flash memory and transmits the generated commands to the memory controller 30 or other circuits, when the data is written to the flash memory.

The data reading control circuit 32 performs control for transferring data from the flash memory 10 and the memory controller 30 to the host 9. The data reading control circuit 32 generates various reading commands for a data reading request from the host 9, controls an operation of the memory controller 30 and the flash memory, or controls transfer of data to the host 9, when the data is read.

The command management circuit 33 determines a physical block address (hereinafter, also referred to as an NBA) which is a data storage position in the flash memory 10 on the basis of a logical cluster offset (hereinafter, also referred to as an MCO) which is calculated by the data writing control circuit 31.

A process of converting a logical address such as an MCO (logical cluster offset) into a physical address such as an NBA (physical block address) is referred to as a logical-physical conversion process.

The logical cluster offset (also referred to as a media cluster offset) indicates logical position information of a cluster in a logical block. An arrangement of MCOs is uniquely defined from serial numbers of physical blocks forming a logical block. In other words, if there is a defect in a logical block, a number of an MCO corresponding to the defective position is omitted.

The command management circuit 33 transmits commands generated by the data writing control circuit 31 to the memory controller 30 to instruct the memory controller 30 to perform writing operation to the flash memory 10. In addition, the command management circuit 33 transmits a reading command generated by the data reading control circuit 32 to the memory controller 30 to instruct the memory controller 30 to perform reading operation from the flash memory 10.

The lookup table management circuit 34 manages a management table for controlling and managing data transfer between the storage device 8 and the host 9, a management table for controlling and managing an operation of the flash memory 10, and the like. The lookup table management circuit 34 performs a logical-physical conversion process on a logical address transmitted from the host and a physical address in the flash memory 10 by referring to management tables (for example, a forward lookup table and a lookup table) stored in the RAM 2.

In addition, the controller 3 includes an ECC circuit which generates an error checking and correcting code to data which is to be written to the flash memory for each predetermined data unit, or a circuit region 39 which includes a software or firmware buffer controlling operations of the storage device 8 and the memories 1 and 2.

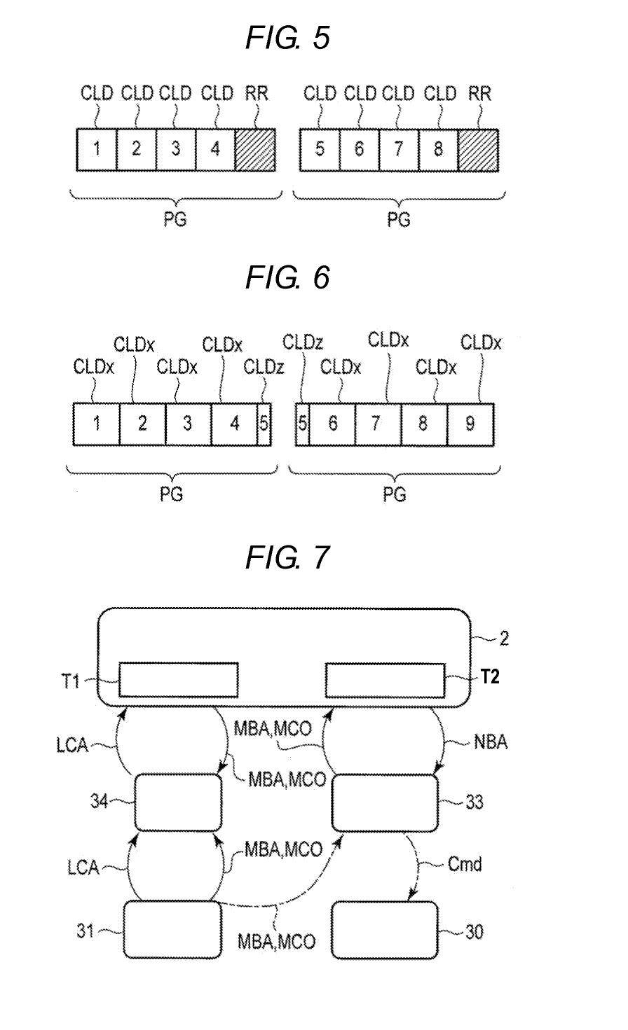

FIGS. 5 and 6 are diagrams schematically illustrating a relationship between a page of the flash memory and data stored in the page.

FIG. 5 shows an example in which four cluster data items are stored in one page (physical page) PG of the NAND type flash memory 10.

In the example shown in FIG. 5, eight cluster data items CLD are stored in the two physical pages PG, each of which has five logical data storage regions including a reserve region RR. The reserve region RR is a data storage region which is reserved for function enhancement (extension). A logical cluster address (hereinafter, also referred to as an LCA) is assigned to each cluster data item.

In the example shown in FIG. 6, a size of the cluster data CLDx is larger than a size of the cluster data CLD shown in FIG. 5. The reason why the size of the cluster data CLD increases is that a size of user data increases or there is a case where a size of an ECC code increases in order to improve an error checking and correcting capability of the ECC code. The storage device 8 of the exemplary embodiment can adjust a size of cluster data stored in a page.

In the example shown in FIG. 6, the reserve region is also used as a data storage region. Nine cluster data items CLDx and CLDz are stored in two physical pages PG by using the reserve regions and storing the data items CLDx and CLDz across entire portions of two physical pages PG. A single cluster data item CLDz is divided into two parts (data portions) and stored across two different pages PG. The two different physical pages PG have continuous physical addresses.

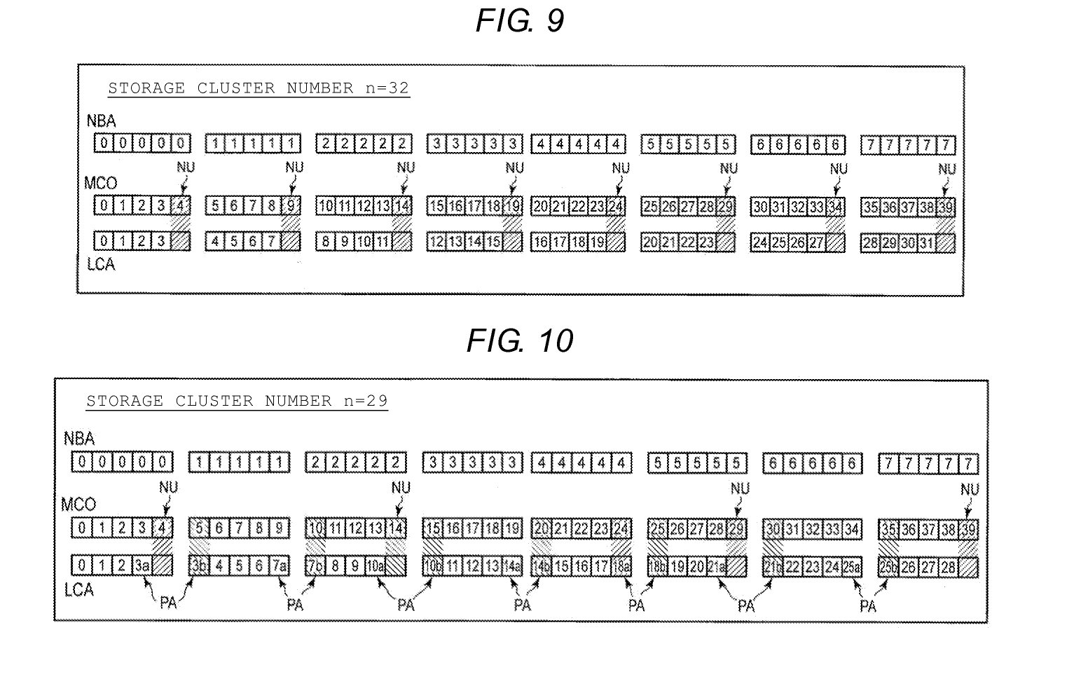

As a relationship between an LCA (logical cluster address) and an MCO (logical cluster offset), typically, a single MCO is associated with a single LCA. In addition, each MCO is associated with a single NBA (physical block address). The associations are shown in FIG. 9. The LCA, MCO and NBA are controlled using this relationship. However, as shown in FIG. 6, if a certain cluster data item CLDz spans the boundaries of two physical pages PG, there is a case where two MCOs and two NBAs are associated with a single LCA corresponding to the certain cluster data item CLDz.

The storage device of the exemplary embodiment includes a controller (also referred to as a memory access controlling unit) which can select any number of clusters which can be stored in a plurality of pages of the flash memory 10 and can write cluster data over boundaries of the pages.

The storage device 8 of the exemplary embodiment includes a page-over handling MCO generation circuit (first circuit) 319 and a page-over logical-physical conversion processing circuit (second circuit) 331.

The page-over handling MCO generation circuit 319 is provided in, for example, the data writing control circuit 31. The page-over logical-physical conversion processing circuit 331 is provided in, for example, the command management circuit 33.

The page-over handling MCO generation circuit (also referred to as a logical storage position generation unit or calculation unit) 319 generates a logical cluster offset (MCO) from a logical cluster address (LCA). The page-over handling MCO generation circuit 319 determines the maximum number of MCOs for all of the physical pages (not only for a specific physical page) according to the maximum number of MCOs managed for a single page.

When an MCO is generated from an LCA, the page-over handling MCO generation circuit 319 calculates the MCO in consideration of whether or not cluster data is divided and stored in a plurality of pages. The page-over handling MCO generation circuit 319 can not only generate an MCO corresponding to an LCA of cluster data which is not divided and is stored in one page but also generate an MCO corresponding to an LCA of cluster data which is stored across two pages.

The page-over logical-physical conversion processing circuit (also referred to as a logical-physical conversion unit) 331 calculates a physical block address (NBA) from the calculated MCO by referring to a logical-physical conversion table (hereinafter, also referred to as an L2P table).

When the NBA is calculated, the page-over logical-physical conversion processing circuit 331 uniquely determines a leading position of an NBA for a single MCO regardless of a difference in a total number of clusters which can be stored in a predetermined physical page. In addition, if the page-over logical-physical conversion processing circuit 331 detects an MCO assigned to an LCA of cluster data spanning pages, a second logical-physical conversion process is performed on a single LCA (MCO).

The page-over handling MCO generation circuit 319 performs the following processes.

The data writing control circuit 31 (and the page-over handling MCO generation circuit 319) issues a request for a logical block address (hereinafter, also referred to as an MBA) indicating an address in which data should be written, to the CPU 37.

When the MBA is received, the page-over handling MCO generation circuit 319 determines a position where writing starts on the basis of the received MBA.

The page-over handling MCO generation circuit 319 calculates a logical writing position (MCO) at which cluster data is stored in a logical block, from the logical cluster address (LCA) which is information added to data from the host 9. The logical cluster address (LCA) is a unique cluster number in the system (i.e., unique to the host and the storage device). For example, if a single cluster includes eight sectors, the quotient obtained by dividing a value of the logical block address (MBA) by 8 corresponds to an LCA.

The page-over handling MCO generation circuit 319 waits until a notification indicating that data of one logical block is stored in the data buffer 311 is transmitted from the data buffer control circuit 313.

If the page-over handling MCO generation circuit 319 receives the notification indicating that the data of one logical block is stored in the data buffer 311, the page-over handling MCO generation circuit 319 transmits an address of a storage destination in which the data should be written in the data buffer 311 and an MCO indicating a logical writing position of the data, to the writing command generation circuit 312.

Successively, the writing command generation circuit 312 of the data writing control circuit 31 generates various commands for writing. The command management circuit 33 adjusts an order of the generated various commands to be executed. The command management circuit 33 issues a writing command to the memory controller 30 of each channel.

In addition, the above-described respective internal constituent elements of the controller 3 are provided in the controller 30 by using firmware, hardware (circuit), software (program), and a combination thereof.

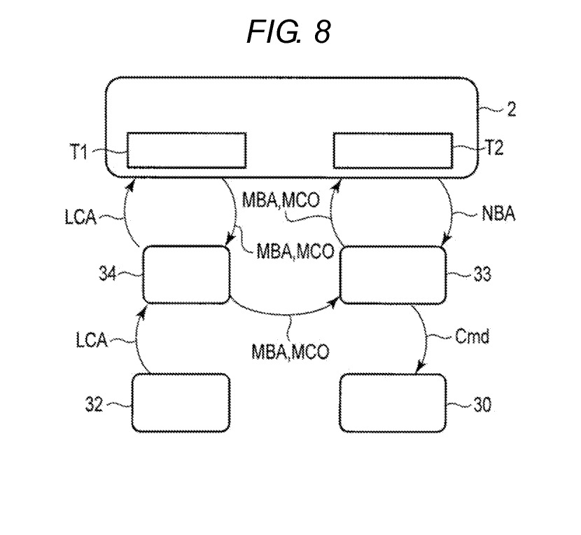

FIGS. 7 and 8 are diagrams schematically illustrating a conversion process on a logical address and a physical address in the storage device of the exemplary embodiment.

FIG. 7 is a diagram schematically illustrating a flow of an LCA, an MCO, and an NBA inside the controller when the storage device of the exemplary embodiment performs a writing operation.

In the writing operation of the storage device, the data writing control circuit (WC) 31 receives a writing request from the host via the host interface controller.

As shown in FIG. 7, the page-over handling MCO generation circuit 319 of the data writing control circuit 31 transmits an LCA and related data of a generated MCO to the lookup table management circuit 34. The lookup table management circuit 34 stores the related data (also referred to as management data, a lookup table, or a first table) in an external memory (for example, the RAM 2 or a DDR-DRAM) of the controller 3 in order to prepare for an operation when data reading is requested. The related data T1 of the LCA and the MCO generated by the page-over handling MCO generation circuit 319 of the data writing control circuit 31 is a forward lookup table T1.

The forward lookup table T1 is a table for managing a storage position of logical data with the cluster unit in the flash memory 10. Thereby, a storage position of data can be managed in the flash memory from the logical address (LCA). A plurality of LCAs and MCOs which respectively correspond to the LCAs are set as entries in the forward lookup table T1, and values of a plurality of LCAs and values of a plurality of MCOs, corresponding to each other, are shown in the table T1.

The page-over handling MCO generation circuit 319 of the data writing control circuit 31 transmits the MCO to the command management circuit 33 at substantially same time as transmitting the LCA and the MCO to the lookup table management circuit 34.

The command management circuit 33 performs a logical-physical conversion process on the MBA and the MCO on the basis of the received MBA and MCO by referring to the logical-physical conversion table T2 stored in the RAM 2, and thereby calculates an NBA indicating a physical address of a writing destination of the flash memory. In addition, the command management circuit 33 determines whether or not there are MCOs corresponding to cluster data spanning boundaries of pages among a plurality of received MCOs. If there are MCOs corresponding to cluster data spanning pages, the command management circuit 33 calculates a value of an MCO (hereinafter, referred to as an xMCO) which is not set as an entry (not shown on the table) in the forward lookup table T1 of the two MCOs assigned to an LCA of the cluster data spanning the pages, from a value of the MCO in the forward lookup table T1.

The command management circuit 33 transmits a writing command Cmd to the memory controller 30, and data is written to the flash memory 10 having a physical address indicated by the NBA.

FIG. 8 is a diagram schematically illustrating a flow of an LCA, an MCO, and an NBA in the controller when the storage device of the exemplary embodiment performs a reading operation.

In a reading operation, the data reading control circuit 32 receives a request for reading data stored in one or more pages from the host via the host interface controller.

The data reading control circuit 32 transmits (notifies) an LCA (or a plurality of LCAs) to the lookup table management circuit 34.

The lookup table management circuit 34 acquires an MBA and an MCO corresponding to the received LCA from the received LCA by referring to the forward lookup table T1.

The lookup table management circuit 34 transmits the acquired MBA and MCO to the command management circuit 33. The command management circuit 33 performs a logical-physical conversion process on the MCO on the basis of the logical-physical conversion table T2 stored in the RAM 2 to calculate an NBA of the flash memory which is a reading source. If there is cluster data stored across pages, an xMCO which is not shown in the forward lookup table T1 of two MCOs corresponding to an LCA spanning the pages is obtained through a calculation of a value of the MCO set as an entry in the forward lookup table T1.

The command management circuit 33 transmits a reading command Cmd to the memory controller 30, and data is read from the flash memory 10 having an address indicated by the NBA.

Here, a description will be made of a conversion process of an address executed when data is written or is read by the controller of the storage device of the exemplary embodiment.

Calculation of Logical Cluster Address and Logical Cluster Offset

First, with reference to FIGS. 9 and 10, a description will be made of a relationship between a physical address and a logical address for describing an operation of the storage device of the exemplary embodiment.

Here, a description will be made of an address conversion process performed when data of 32 clusters and 28 clusters is written in and is read from eight physical pages of the memory (flash memory) included in the storage device.

FIGS. 9 and 10 are diagrams illustrating a relationship between an LCA and an MCO when 32 clusters or 28 clusters can be assigned to eight physical pages.

Hereinafter, the storage unit of data formed by a plurality of pages used to write data is referred to as a page group. In addition, a plurality of LCAs are referred to as an LCA group, and a plurality of MCOs are referred to as an MCO group.

As described above, in the storage device of the exemplary embodiment, five MCOs can be assigned to one physical page. In this case, 40 MCOs are assigned to eight physical pages. Different MCOs are assigned to each LCA depending on the number 32 or 28 of clusters.

The number of clusters stored in a page group is referred to as a storage cluster number, and the number thereof is indicated by “n”.

FIG. 9 shows a relationship between an LCA, an MCO, and an NBA when the storage cluster number n is 32.

As shown in FIG. 9, the NBAs corresponding to LCAs and MCOs of the same page have the same value.

In the example shown in FIG. 9, five MCOs are assigned to one page (NBA). Four LCAs (cluster data) are stored in each page. In the example shown in FIG. 9, the LCA and the MCO have a one-to-one relationship. One MCO of each page is an unused region NU.

FIG. 10 shows a relationship between an LCA, an MCO, and an NBA when the storage cluster number n is 29.

In the example shown in FIG. 10, the respective LCAs having values 3 (3a, 3b), 7 (7a, 7b), 10 (10a, 10b), 14 (14a, 14b), 18 (18a, 18b), 21 (21a, 21b), and 25 (25a, 25b) store cluster data divided into a plurality of data items which are stored in different pages. The divided data items PA and a single LCA corresponding to the divided data items PA span the boundaries of two pages PG.

Therefore, two MCOs and two NBAs are associated with a single LCA corresponding to divided data items.

An LCA corresponding to cluster data stored over two pages is discriminated by the CPU 37, the data writing control circuit 31, or the page-over handling MCO generation circuit 319 performing a calculation based on a size of the cluster data or a size of a page of the flash memory.

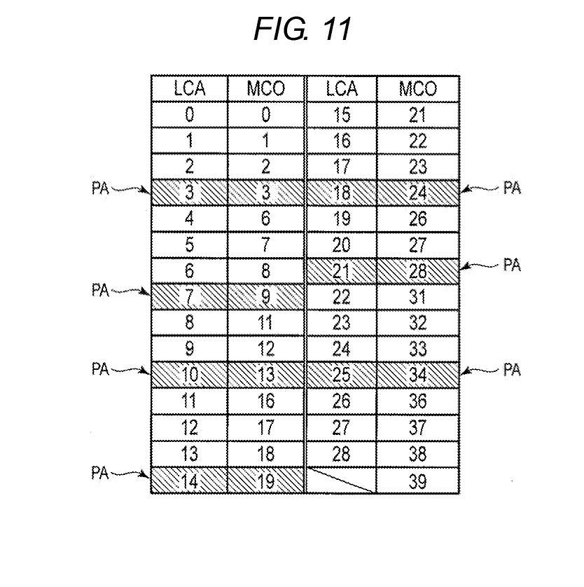

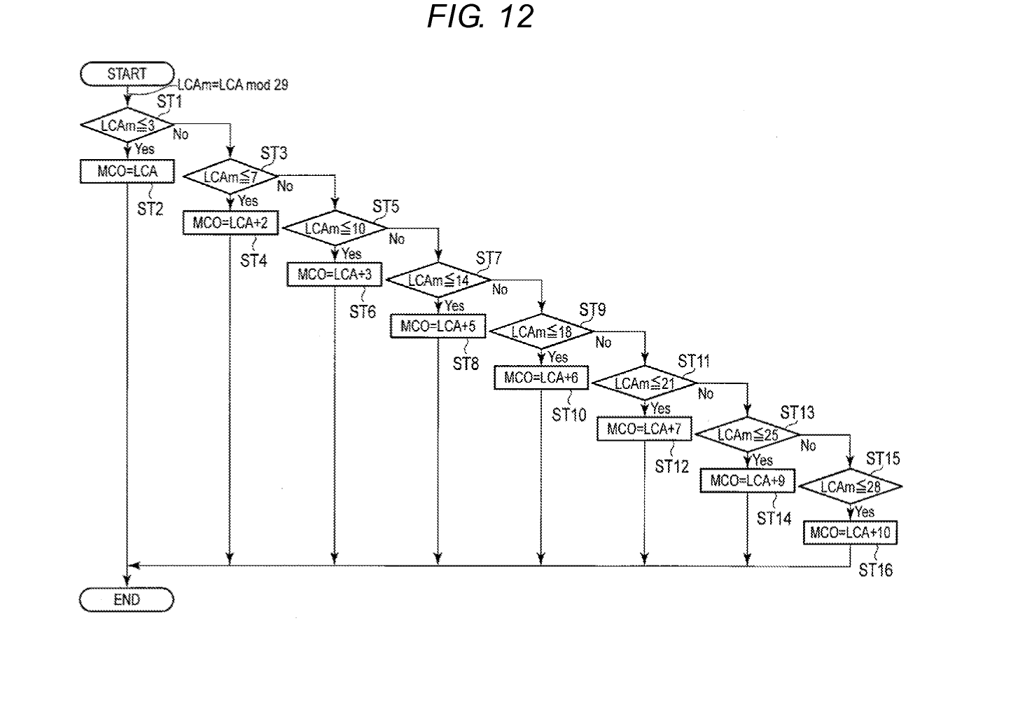

FIG. 11 shows an example of a management table of a relationship between an LCA and an MCO when a certain cluster data item is divided into a plurality of parts which are written in different pages (if the cluster data spans pages).

The management table (forward lookup table) shown in FIG. 11 corresponds to cluster data PA in which LCAs assigned with the values 3, 7, 10, 14, 18, 21 and 25 span different pages when the storage cluster number is 29.

As shown in FIG. 11, in each LCA spanning pages, the LCA and the MCO are correlated with each other as follows. The MCO having the value “3” is assigned to the LCA having the value “3”. The MCO having the value “9” is assigned to the LCA having the value “7”. The MCO having the value “13” is assigned to the LCA having the value “10”. The MCO having the value “19” is assigned to the LCA having the value “14”. The MCO having the value “24” is assigned to the LCA having the value “18”. The MCO having the value “28” is assigned to the LCA having the value “12”. The MCO having the value “34” is assigned to the LCA having the value “25”.

The MCOs with the values 4, 5, 10, 14, 15, 20, 25, 29, and 35 of the MCO group are skipped, and these values of the MCOs are not set as entries in the forward lookup table T1 stored in the RAM 2. The MCO (skipped MCO) which is not set as an entry in the forward lookup table T1 is an MCO having a greater value or an unused MCO when two MCOs are associated with an LCA of cluster data spanning pages.

If the storage cluster number is 29, 29 MCOs are used for 29 LCAs, and a management table (forward lookup table) indicating a relationship between an LCA and an MCO is formed. As above, if there is cluster data (LCA) spanning pages, a management table of logical and physical addresses is generated such that an LCA and an MCO would correspond to each other in a one-to-one relationship. Therefore, even if there is an LCA (cluster data) spanning pages, the number of MCOs in the management table is the same as the number of LCAs, and the management table with a small data size is generated.

A management table indicating a relationship between an LCA group including LCAs of cluster data spanning pages and an MCO group is generated through a calculation (for example, a mod calculation) of the LCA group.

With reference to FIG. 12, a description will be made of a method of generating an MCO from an LCA corresponding to cluster data spanning pages. Here, a description will be made of a method of generating an MCO (MCO calculation) in a case of an LCA group shown in FIGS. 10 and 11.

For example, an MCO is calculated by performing the mod calculation on an LCA. In other words, a value of an MCO is determined based on a residual value obtained when a value of the LCA is divided by the value “n” (here, 29) indicating the storage cluster number. The calculation for generating this MCO may be performed by the page-over handling MCO generation circuit 319 of the data writing control circuit 31, may be performed by the CPU 37, or may be performed by firmware of the controller 3.

As shown in FIG. 12, a residual value (integer) obtained when a value of a certain LCA is divided by 29 is input as an LCAm. In addition, a certain determination value is used, and magnitudes of the determination value and the LCAm are compared with each other. A value of an LCA corresponding to cluster data stored across pages is used as the determination value. As described above, it can be discriminated through a calculation whether or not cluster data spans a plurality of pages.

It is determined whether or not the LCAm is equal to or less than 3 (step ST1). A determination value (here, 3) used for determination of the LCAm is a value of an LCA of cluster data stored over pages.

If the LCAm (LCA) is 0, 1, 2 and 3, LCAm≦3 is satisfied. In this case, MCO=LCA is calculated (step ST2). In other words, the calculated LCA is treated as an MCO. Thereby, as shown in FIG. 11, MCOs having the values 0, 1, 2 and 3 are respectively generated so as to correspond to LCAs having the values 0, 1, 2 and 3.

If a value of the LCAm in the LCA which is a determination target is not equal to or less than 3 in step ST1, it is determined that the LCAm is equal to or less than 7 (and the LCAm is equal to or more than 3) (step ST3). The determination value 7 in step ST3 is a value of an LCA corresponding to cluster data stored over pages.

If values of the LCAs are 4, 5, 6 and 7, a relationship of LCAm≦7 (and 3<LCAm) is satisfied. In this case, a calculation is performed in which “2” is added to the values (here, 4, 5, 6 and 7) of the LCAs corresponding to the LCAm which is a determination target (step ST4).

If LCAs respectively have the values 4, 5, 6 and 7 as shown in FIG. 11 through the calculation (LCA+2) in step ST4, the condition in step ST3 is satisfied, and MCOs which respectively have the values 6, 7, 8 and 9 are generated from the LCAs.

In addition, the reason why an addition value to LCAs for generating MCO is “2” in the calculation in step ST4 is that the value “1” caused by cluster data corresponding to an LCA spanning pages and the value “1” caused by the presence of an MCO to which an LCA is not assigned in the previous MCO generation step (the determination step of the LCAm) are added to “0” which is the addition value in the previous MCO generation step. As above, in the relationship between the LCA and the MCO, an addition value for generating an MCO in a certain step is set in each LCAm determination step or MCO generation step by adding a value (for example, “1”) based on the number of skips of MCO values (the number of defective MCOs) and a value (for example, “1”) based on page spanning of cluster data (LCA) to an addition value used in the previous MCO generation step.

If a value of the LCAm does not satisfy the determination condition (3<LCAm≦7) in step ST3, it is determined whether or not the LCAm is equal to or less than 10 which is a value of an LCA corresponding to cluster data stored over pages (and whether or not the LCAm is equal to or more than 7) (step ST5).

A calculation is performed in which 3 is added to an LCA value corresponding to an LCAm satisfying the determination condition (step ST6). If values of LCAs are 8, 9 and 10, a relationship of the LCAm≦10 (and 7<LCAm) is satisfied, and, through the calculation (LCA+3) in step ST6, as shown in FIG. 11, and MCOs which respectively have the values 11, 12 and 13 are obtained from the LCAs which respectively have 8, 9 and 10.

In addition, here, since the MCO is not skipped in the previous LCAm determination step and the MCO generation step (ST3 and ST4), an addition value to an LCA for generating an MCO in step ST6 is only the value “1” caused by cluster data (LCA) spanning pages.

If a value of the LCAm does not satisfy the determination condition (7<LCAm≦10) in step ST5, it is determined whether or not a value of the LCAm is equal to or less than “14” (step ST7).

If a relationship of the LCAm≦14 (and 10<LCAm) is satisfied, a calculation is performed in which “5” is added to an LCA value corresponding to an LCAm satisfying the determination condition (step ST8). If values of LCAs are 11, 12, 13 and 14, through the calculation (LCA+5) in step ST8, as shown in FIG. 11, MCOs which respectively have the values 16, 17, 18 and 19 are generated from the LCAs which respectively have the values 11, 12, 13 and 14.

If a value of the LCAm does not satisfy the determination condition (10<LCAm≦14) in step ST7, it is determined whether or not a value of the LCAm is equal to or less than “18” (step ST9).

If this relationship (LCAm≦18) is satisfied, a calculation is performed in which “6” is added to an LCA value corresponding to an LCAm satisfying the determination condition (step ST10).

If values of LCAs are 15, 16, 17 and 18, residual values of LCAs for the storage cluster number are 18 or less. Through the calculation (LCA+6) in step ST10, as shown in FIG. 11, MCOs which respectively have the values 21, 22, 23 and 24 are generated from the LCAs which respectively have the values 15, 16, 17 and 18.

If a value of the LCAm does not satisfy the relationship (14<LCAm≦18) in step ST9, it is determined whether or not a value of the LCAm is equal to or less than “21” (and 18<LCAm) (step ST11).

If a relationship of LCAm≦21 is satisfied, a calculation is performed in which “7” is added to an LCA value (step ST12). If values of LCAs are 19, 20 and 21, values of the LCAm in the LCAs are 21 or less. Through the calculation (LCA+7) in step ST12, as shown in FIG. 11, and MCOs which respectively have the values 26, 27 and 28 are generated from the LCAs which respectively have the values 19, 20 and 21.

If a value of the LCAm does not satisfy the determination condition (18<LCAm≦21) in step ST11, it is determined whether or not the LCAm having a value greater than 21 is equal to or less than “25” (step ST13).

If a relationship of LCAm≦25 is satisfied, a calculation is performed in which “9” is added to an LCA value corresponding to the LCAm (step ST14). If values of LCAs are 22, 23, 24 and 25, values (residual values) of the LCAm in the LCAs are 25 or less. Through the calculation (LCA+9) in step ST14, as shown in FIG. 11, and MCOs which respectively have the values 31, 32, 33 and 34 are generated from the LCAs which respectively have the values 22, 23, 24 and 25.

If a value of the LCAm does not satisfy the determination condition (21<LCAm≦25) in step ST13, it is determined whether or not the LCAm having a value greater than 25 is equal to or less than “28” (step ST15).

If a relationship of LCAm≦28 is satisfied, a calculation is performed in which “10” is added to an LCA value corresponding to the LCAm (step ST16). If values of LCAs are 26, 27 and 28, residual values of the LCAs are 28 or less. Through the calculation (LCA+10) in step ST16, as shown in FIG. 11, and MCOs which respectively have the values 36, 37 and 38 are generated from the LCAs which respectively have the values 26, 27 and 28.

“28” used as the determination value is the maximum value of the LCA corresponding to the storage cluster number.

The determination process in which the maximum value of an LCA corresponding to the storage cluster number is used as a determination value is performed, and the generation process of an MCO for an LCA finishes.

The generation process of an MCO is performed the number of times (here, 29) corresponding to the storage cluster number, and thus a management table indicating a relationship between the LCA group and the MCO group when cluster data stored over pages is included is created. The created management table (forward lookup table) is stored in the RAM 2.

The determination through the mod calculation of a determination value and an LCA is performed for each LCA of cluster data stored over pages. In other words, values (here, 3, 7, 10, 14, 18, 21, and 25) of LCAs corresponding to cluster data stored over pages are used for a determination value for a residual value (LCAm) of an LCA value regarding the storage cluster number. Thereby, a value of an MCO corresponding to an LCA is calculated from an LCA group including an LCA corresponding to cluster data stored over pages, and a forward lookup table indicating a relationship between the LCA and the MCO is created.

As above, if the storage cluster number n is 29, the number of MCOs for the number 29 of LCAs assigned to data to be written is 29. Therefore, a data size of the management table is the necessary minimum size.

Here, a description is made of a relationship between an LCA and an MCO when the storage cluster number for eight pages is 29, and a management table indicating the relationship. However, also in relation to cluster groups other than the storage cluster number 29, an MCO group corresponding to a cluster group stored in one or more pages is calculated through the mod calculation to generate a management table.

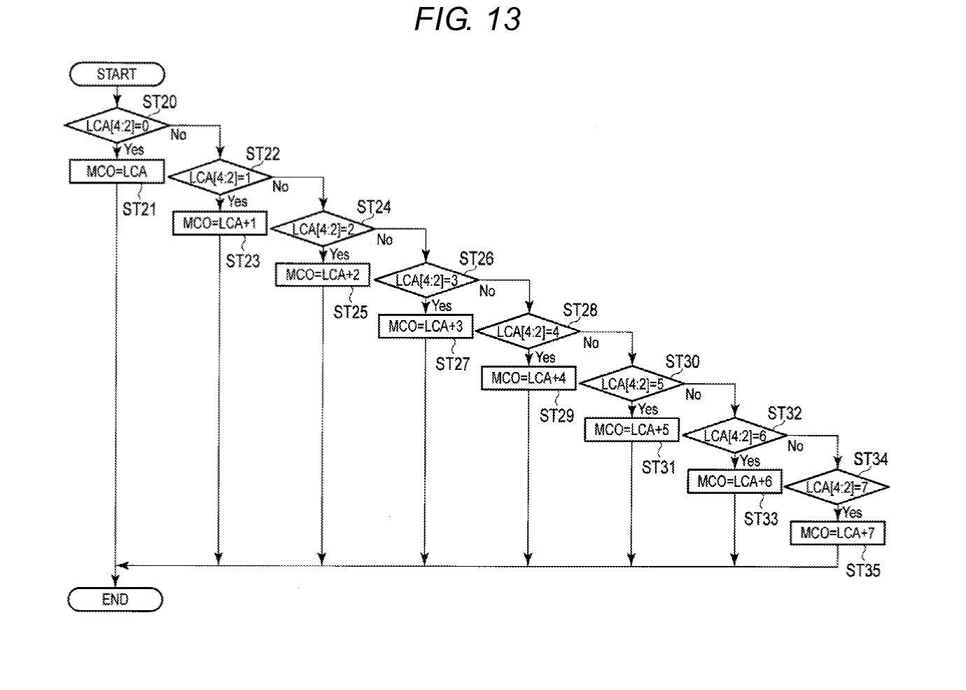

With reference to FIG. 13, a description will be made of a method of generating an MCO from an LCA when cluster data spanning pages is not in an LCA group. Here, as shown in FIG. 9, a description will be made of a method of calculating an MCO when the storage cluster number n is 32 in an LCA group which does not include cluster data spanning pages.

If an LCA (cluster data) group stored in one or more certain pages does not include an LCA spanning pages, a complex calculation as in the case where an LCA group includes an LCA spanning pages as shown in FIG. 12 is not performed on an LCA group which does not include an LCA spanning pages.

For example, if data is written in eight pages, a value indicated by bits (from the third bit to the fifth bit when counted from the least significant bit in the LCA) of three digits of LCA[4:2] included in each LCA corresponds to a value which indicates one of eight pages. For example, if LCA[4:2] is “000” (=0), the LCA indicates an LCA assigned to a page (first page) having an NBA of “0”. For example, if LCA[4:2] is “100” (=4), the LCA indicates an LCA assigned to a page (fifth page) having an NBA of “4”.

If an LCA spanning pages is not in an LCA group of written data, values of MCOs corresponding to LCAs are respectively generated through the following calculation shown in FIG. 13 by using a value in the LCA indicating a page in which the LCA is stored.

As shown in FIG. 13, in relation to an LCA of 32 LCAs having any one of the values 0 to 31, a process of generating an MCO corresponding to the LCA is performed.

It is determined whether or not a value of LCA[4:2] in an LCA with a certain input value is “0” (000) (step ST20).

If the value of LCA[4:2] of the determination target LCA is equal to “0”, the value of LCA[4:2] of the LCA, that is, “0” which is a value indicating a page to which the determination target LCA is assigned is added to a value of the LCA, and the addition result is generated as a value of an MCO corresponding to the determination target LCA (step ST21). A calculation of an MCO for an LCA satisfying the determination condition in step ST20 is completed.

If cluster data does not span a plurality of (two) pages, and four cluster data items are written in one page, 0 is added to LCAs which respectively have the values 0, 1, 2 and 3, and MCOs which respectively have the values 0, 1, 2 and 3 are generated so as to correspond to the LCAs.

If the value of LCA[4:2] of the input LCA is not “0” in step ST20, it is then determined whether or not LCA[4:2] of the LCA is “1” (001) (step ST22).

If the determined value of LCA[4:2] of the LCA is 1, a value obtained by adding 1 to the value of the LCA is calculated as a value of an MCO corresponding to the LCA which satisfies the determination condition, and the MCO corresponding to the LCA which satisfies the determination condition is generated (step ST23). In steps ST22 and ST23, MCOs which respectively have the values 5, 6, 7 and 8 are generated for LCAs which respectively have the values 4, 5, 6 and 7. In calculating an MCO for an LCA group which does not include an LCA corresponding to cluster data stored over pages, an addition value for an LCA used to calculate an MCO is a value of LCA[4:2] of an LCA which satisfies a relationship of the value of LCA[4:2] and a determination value, and a value of LCA[4:2] is 1 in LCAs having the values 4, 5, 6 and 7.

If the value of LCA[4:2] of the input LCA is not “1” and the determination condition in step ST22 is not satisfied, it is determined whether or not the value of LCA[4:2] of the LCA is “2” (010) (step ST24).

If the determined value of LCA[4:2] of the LCA is 2, an MCO with a value obtained by adding 2 to the value of the LCA which is a determination target is generated as an MCO corresponding to the LCA (step ST25). Thereby, as shown in FIG. 9, MCOs which respectively have the values 10, 11, 12 and 13 are generated for LCAs which respectively have the values 8, 9, 10 and 11.

If the value of LCA[4:2] of the input LCA is not “2” and the determination condition in step ST24 is not satisfied, it is determined whether or not LCA[4:2] of the LCA is “3” (011) (step ST26).

If the determined value of LCA[4:2] of the LCA is 3, an MCO with a value obtained by adding 3 to the value of the LCA is generated as an MCO corresponding to the LCA (step ST27). Thereby, as shown in FIG. 9, MCOs which respectively have the values 15, 16, 17 and 18 are generated for LCAs which respectively have the values 12, 13, 14 and 15.

If the value of LCA[4:2] of the input LCA does not satisfy the determination condition (LCA[4:2]=3) in step ST26, it is determined whether or not the value of LCA[4:2] of the LCA is “4” (100) (step ST28).

If the determined value of LCA[4:2] of the LCA is 4, an MCO with a value obtained by adding 4 to the value of the LCA is generated as an MCO corresponding to the LCA (step ST29). MCOs which respectively have the values 20, 21, 22 and 23 are generated for LCAs which respectively have the values 16, 17, 18 and 19.

If the value of LCA[4:2] of the input LCA does not satisfy the determination condition (LCA[4:2]=4) in step ST28, it is determined whether or not the value of LCA[4:2] of the LCA is “5” (101) (step ST30).

If the determined value of LCA[4:2] of the LCA is 5, an MCO with a value obtained by adding 5 to the value of the LCA is generated as an MCO corresponding to the LCA (step ST31). MCOs which respectively have the values 25, 26, 27 and 28 are generated for LCAs which respectively have the values 20, 21, 22 and 23.

If the value of LCA[4:2] of the input LCA is not “5” in step ST30, it is determined whether or not the value of LCA [4:2] of the LCA is “6” (110) (step ST32).

If the determined value of LCA[4:2] of the LCA is 6, an MCO with a value obtained by adding 6 to the value of the LCA is generated as an MCO corresponding to the LCA (step ST33). MCOs which respectively have the values 30, 31, 32 and 33 are generated for LCAs which respectively have the values 24, 25, 26 and 27.

If the value of LCA[4:2] of the input LCA which is a calculation target of MCO is not “5” in step ST32, it is determined whether or not the value of LCA[4:2] of the LCA is “6” (110) (step ST32).

If the determined value of LCA[4:2] of the LCA is 6, an MCO with a value obtained by adding 6 to the value of the LCA is generated as an MCO corresponding to the LCA (step ST33). MCOs which respectively have the values 30, 31, 32 and 33 are generated for LCAs which respectively have the values 24, 25, 26 and 27.

If the value of LCA[4:2] of the determination target LCA for calculating an MCO is not “6”, it is determined whether or not the value of LCA[4:2] of the LCA is “7” (111) which indicates the maximum value among values indicating a plurality of pages in which data to be written is stored (step ST34).

Since the value of LCA[4:2] of the determination target LCA is 7 in step ST34, an MCO with a value obtained by adding 7 to the value of the LCA is generated as an MCO corresponding to the LCA (step ST35). MCOs which respectively have the values 35, 36, 37 and 38 are generated for LCAs which respectively have the values 28, 29, 30 and 31.

As above, if stored cluster data does not span a plurality of pages, MCOs corresponding to LCAs are respectively generated based on a value (for example, a value of an NBA) indicating a page to which the LCA is assigned. Thereby, the forward lookup table T1 indicating a relationship between the LCA and the MCO is created and is stored in the RAM 2.

Process of Calculating Two Logical Storage Positions Assigned to Single Logical Address

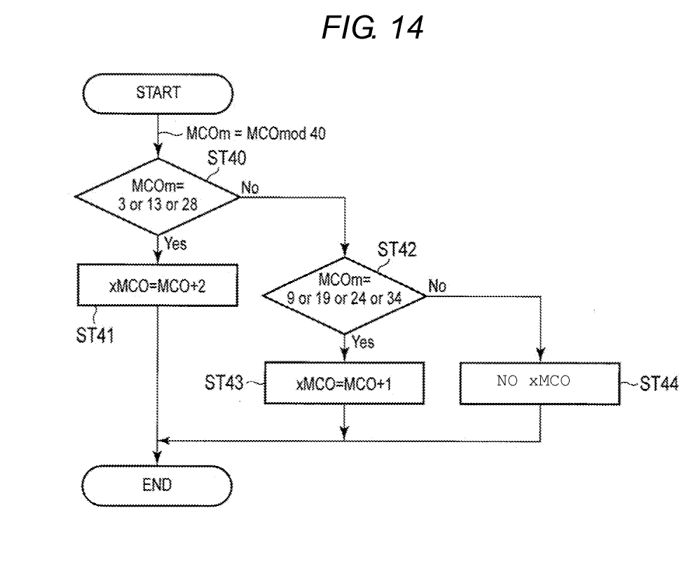

With reference to FIG. 14, a description will be made of a method of calculating an MCO corresponding to a logical address (LCA) spanning a plurality of physical addresses (here, pages).

As described above, the MCOs obtained through the calculations in FIGS. 9 to 13 are transmitted to the command management circuit 33. The command management circuit 33 determines whether or not there is an xMCO (divided MCO) which forms a pair with an MCO in the forward lookup table, corresponding to an LCA spanning pages, based on the values of the MCOs shown (set as entries) in the forward lookup table.

If there is an xMCO which is not set as an entry in the forward lookup table and in which data is stored, a value of the xMCO is calculated by at least one of the command management circuit 33 and the page-over logical-physical conversion processing circuit 331 thereof through the following process. In addition, the page-over logical-physical conversion processing circuit 331 may be provided as software or firmware.

It is determined whether or not the MCO (logical cluster offset) group obtained through the calculations in FIGS. 9 to 13 includes an MCO (xMCO) corresponding to an LCA (logical cluster address or cluster data) spanning pages on the basis of the values of the MCOs of the MCO group. This determination is performed by the page-over logical-physical conversion processing circuit 331 of the command management circuit 33.

If an MCO or an xMCO assigned to an LCA corresponding to cluster data which spans a plurality of pages is in the MCO group, a process of calculating a value of the xMCO is performed by the page-over logical-physical conversion processing circuit 331.

FIG. 14 is a flowchart illustrating an example of the calculation of an MCO (xMCO) corresponding to an LCA spanning a plurality of pages. Here, a description will be made of a calculation of an xMCO corresponding to an LCA corresponding to cluster data spanning pages by exemplifying the relationship between the LCA group and the MCO group shown in FIGS. 10 and 11.

In the exemplary embodiment, five MCOs are assigned to one page. Therefore, a total number of MCOs in all the pages (here, eight pages) in which cluster data is stored is 40. A value of an xMCO corresponding to an LCA spanning pages is calculated from a residual value obtained when the value of the MCO is divided by the number (40) of all the MCOs through the mod calculation.

As shown in FIG. 11, if values of the MCOs are 3, 13 and 28, two values of the MCOs which are continued immediately thereafter are skipped. In addition, if values of the MCOs are 9, 19, 23 and 34, one value of the MCO which is continued immediately thereafter is skipped. In relation to the other values of the MCOs, values continued thereafter are not skipped, and the values of the MCOs are continuously located. As above, a setting for the mod calculation for obtaining an xMCO which is not shown in the table is generated depending on whether values subsequent to a value of a certain MCO are skipped or are continuously located.

Various settings for the mod calculation are performed by the page-over logical-physical conversion processing circuit 331 of the command management circuit 33 on the basis of the forward lookup table (the lookup table or the first table) as shown in FIG. 11, and the mod calculation is performed as follows on an input MCO group.

As shown in FIG. 14, it is determined whether or not a residual value (hereinafter, referred to as an MCOm) obtained when a value of a certain MCO is divided by 40 is equal to 3, 13, or 28 (step ST40). The determination values 3, 13 and 28 indicate values of MCOs assigned to cluster data stored over pages.

If the obtained value of the MCOm is equal to any one of 3, 13 and 28, the value of the MCOm has the same value of a leading MCO assigned to an LCA of cluster data spanning pages.

If it is determined that the MCOm obtained in step ST40 is equal to the value 3, 13, or 28, a calculation is performed in which 2 is added to the value of the MCO (=MCOm) which is determined as being equal to the determination value (step ST41). The value (MCO+2) is obtained as an xMCO (divided MCO). If a value of the MCO is 3, a value of the xMCO is 5, and if a value of the MCO is 13, a value of the xMCO is 15. In addition, if a value of the MCO is 28, a value of the xMCO is 30. As shown in FIGS. 10 and 11, the value of the xMCO calculated in steps ST40 and ST41 forms a pair with the leading MCO of two MCOs assigned to an LCA of cluster data spanning pages, and indicates a value of an xMCO which is not set an entry in the forward lookup table.

Thereby, a value of an xMCO (here, 5, 15 or 30) forming a pair with the MCO of 3, 13 or 28 assigned to an LCA of cluster data stored over two pages is obtained.

If the value of the MCOm does not satisfy the determination condition in step ST40, it is determined whether or not the value of the MCOm is equal to 19, 24 or 34 (step ST42). If the value of the MCOm is equal to any one of the values, a calculation is performed in which 1 is added to the value of the determination target MCO, and a value of the xMCO is obtained (step ST43).

As shown in FIG. 10, the value of the xMCO calculated in steps ST42 and ST43 is assigned to an LCA which is the same as the value of the determination target MCO, and is a value of an MCO assigned to an LCA of cluster data spanning two pages.

Thereby, a value of an xMCO (here, 10, 20, 25 or 35) forming a pair with the MCO of 9, 19, 24 or 34 assigned to an LCA of cluster data stored over two pages is obtained.

If the value of the MCOm is not equal to the value of the MCO indicating 3, 13, or 28 in step ST40, and is not equal to 9, 19, 24, or 34 in step ST42, it is determined that there is no xMCO corresponding to the MCOm (step ST44).

Through the process shown in FIG. 14, it is possible to calculate a value of the other MCO which is not stored in the forward lookup table from a value of one MCO which is stored in the forward lookup table of the two MCOs assigned to a single LCA of cluster data spanning two pages.

Two MCOs assigned to a single LCA are obtained through the mod calculation on the MCOs of the forward lookup table, and two NBAs (physical positions) in which divided parts of the cluster data in the single LCA are respectively stored are discriminated based on the values of the two MCOs.

As above, of two MCOs (a pair of MCOs) assigned to an LCA of divided cluster data, the MCO (the leading MCO) with a smaller value is stored in the forward lookup table, and a calculation (for example, the mod calculation) is performed using the MCO with a smaller value to calculate an xMCO, and thereby it is possible to calculate the MCO with a greater value of the pair of MCOs.

In addition, as in FIG. 9, if cluster data which is stored across pages is not in written data, and two MCOs and two NBAs for a single LCA are not in an MCO group, the calculation process in FIG. 14 is not performed.

In the storage device of the exemplary embodiment, MCOs corresponding to the maximum number of clusters stored in a single physical address (for example, a physical page or a page) are set in each physical address of the memory and are managed so as to correspond to any case (data format) where data is stored using two patterns shown in FIGS. 5 and 6. For example, the controller of the storage device of the exemplary embodiment assigns five logical storage positions (for example, logical cluster offsets) to one page, and manages physical addresses (an NBA and a page) and logical addresses (an MBA, an LCA, and an MCO).

In addition, if there is a logical address (for example, a logical cluster address) corresponding to a data unit (for example, cluster data) spanning boundaries of pages, the storage device of the exemplary embodiment performs a calculation using a logical address spanning the boundaries of the pages to generate logical storage position information (logical cluster offset) indicating a relationship between a logical address and a physical address.

In the storage device of the exemplary embodiment, if there is a logical address (logical cluster address) corresponding to a data unit (cluster data) spanning boundaries of pages and two logical storage positions are assigned to a single logical address, one logical storage position is managed using the management table, and the other logical storage position is obtained through a calculation on one logical storage position stored in the management table.

Thereby, the storage device of the exemplary embodiment can manage a logical address (LCA) and a logical storage position (MCO) in a one-to-one relationship in the management table. As a result, a data size of the management table in the exemplary embodiment can be reduced, and thus a storage capacity of the memory storing the management table may not be increased.

In addition, the controller 3 of the storage device of the exemplary embodiment can rapidly calculate a leading address of a page (physical address) in which cluster data is stored, from a value of a logical cluster offset (a logical address or a logical storage position) assigned to the cluster data in the management table regardless of a difference in a total number of clusters which can be stored.

For this reason, according to the storage device of the exemplary embodiment, a cache hit when a reading operation of the memory is performed is rapidly determined. As a result, reading operation characteristics of the storage device can be improved.

(b) Operation

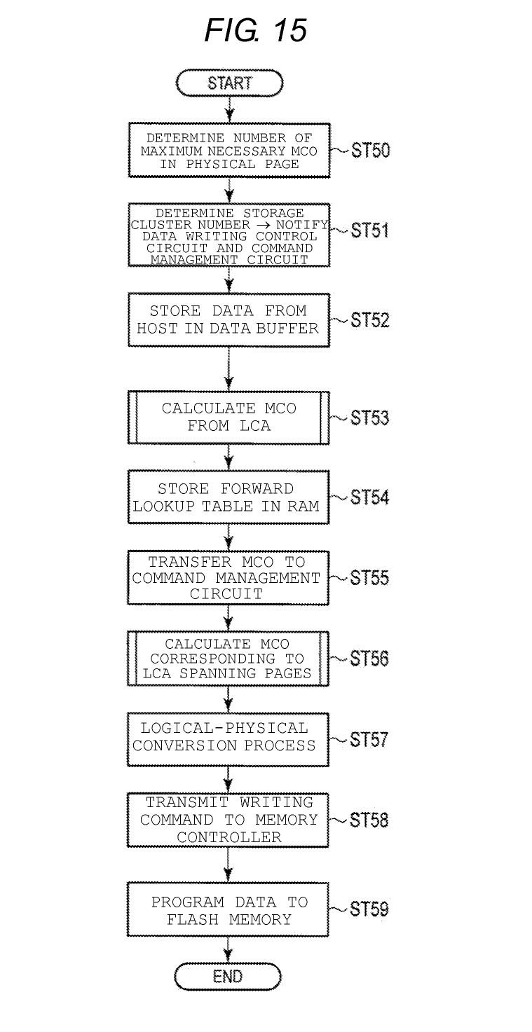

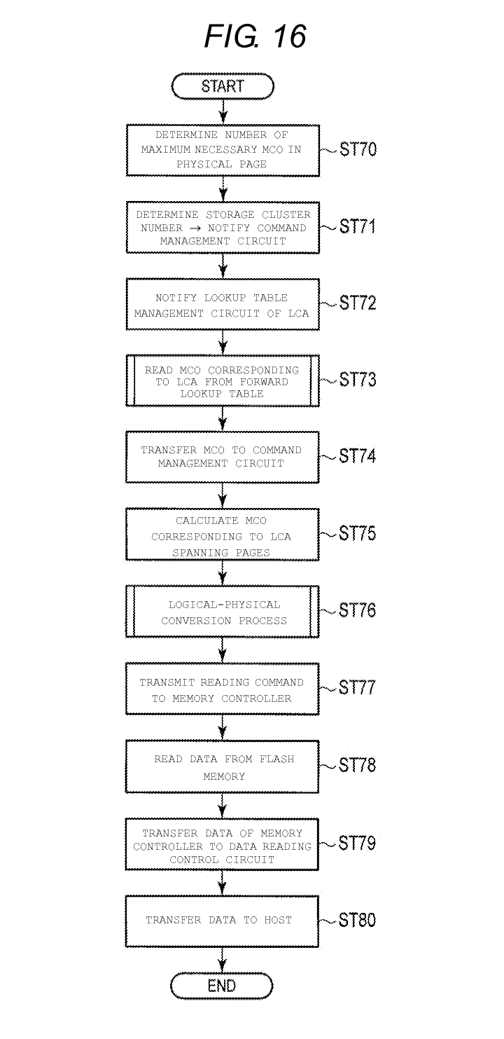

With reference to FIGS. 15 and 16, a description will be made of an operation (an address conversion method or a memory control method) of the storage device of the exemplary embodiment. In addition, the operation of the storage device of the exemplary embodiment will be described with appropriate reference to FIGS. 1 to 14 in addition to FIGS. 15 and 16.

Writing Operation

With reference to FIG. 15, a writing operation of the storage device of the exemplary embodiment will be described.

As shown in FIG. 15, the maximum number of MCOs set in a page is calculated (step ST50). For example, if five MCOs are set in one page, and eight pages are used to write data, the number of MCOs is calculated as forty.

A notification of the number n of storage clusters, which is determined based on a result of the calculation on data to be written, is sent to the data writing control circuit 31 and the command management circuit 33 (step ST51). Thereby, the data writing control circuit 31 and the command management circuit 33 recognize the number of storage clusters assigned to one or more pages used to write data which should be written.

In addition, data (data to be written) from the host 9 is transferred to the data buffer 311 of the data writing control circuit 31 directly or via the RAM 2. The transferred data is stored in the data buffer 311 under the control of the buffer control circuit 313 (step ST52).

In addition, for example, an MCO is calculated from an LCA by the page-over handling MCO generation circuit through a calculation for generating the MCO (logical cluster offset) from the LCA (logical cluster address) as shown in FIGS. 12 and 13, for example, depending on whether or not there is cluster data spanning pages (step ST53). Accordingly, even if there is cluster data spanning pages, the generated MCO has a one-to-one relationship with an LCA in the same manner as a case where there is no cluster data spanning pages.

A forward lookup table (a first table or a lookup table) which is a management table indicating a relationship between the LCA and the MCO is stored in the RAM 2 (step ST54). The forward lookup table is stored in the RAM 2 in preparation for reading data that is to be written in a subsequent operation. In the created table, the MCO and the LCA have a one-to-one relationship. Therefore, it is possible to reduce a size of the table to the minimum size and to thereby suppress an increase in a storage capacity of the RAM storing the management table.

An MCO group is transmitted from the data writing control circuit 31 to the command management circuit 33 (step ST55).

An MCO (xMCO) corresponding to an LCA is calculated by the page-over logical-physical conversion processing circuit 331 of the command management circuit 33 (step ST56). If there is cluster data spanning pages, a value of an xMCO which is not stored in the forward lookup table T1 of two MCOs (MCO and xMCO) assigned to an LCA corresponding to the cluster data which is divided and is stored across two pages is calculated through the mod calculation shown in FIG. 14.

The command management circuit 33 refers to the logical-physical conversion table in the RAM 2, and performs a logical-physical conversion process (step ST57). Thereby, an NBA corresponding to a physical address (a page of the flash memory) is calculated from an MCO indicating a logical position of a cluster in a logical block.

Here, if there are two MCOs (xMCO) assigned to a single LCA corresponding to cluster data spanning two pages, a logical-physical conversion process on the MCO indicating a position at which some of the cluster data is stored and a logical-physical conversion process on the xMCO indicating a position at which the other cluster data is stored are performed.

A writing command is transmitted (issued) from the command management circuit 33 to the memory controller 30 (step ST58).

The memory controller 30 writes (programs) data to the flash memory 10 such that the data is written at a position indicated by the NBA obtained through the logical-physical conversion process, on the basis of a predetermined writing operation in response to the writing command (step ST59).

As described above, data is written to the memory of the storage device of the exemplary embodiment.

Reading Operation

With reference to FIG. 16, a reading operation of the storage device of the exemplary embodiment will be described.

The number of MCOs and the number of storage clusters set in one or more pages which are reading targets are calculated and are determined through the substantially same process as in the writing operation (steps ST70 and ST71). In addition, when the reading operation is performed, a notification of the storage cluster number is sent to the command management circuit 33.

The data reading control circuit 32 notifies the lookup table management circuit 34 of an LCA (an LCA group) corresponding to reading target data (step ST72).

The lookup table management circuit 34 refers to the forward lookup table T1 which is stored in the RAM 2 during the writing on the basis of the LCA, and reads an MCO (an MCO group) corresponding to the LCA (step ST73).

The read MCO (or the MCO group) is transferred to the command management circuit 33 (step ST74).

Here, if cluster data which is written across a plurality of pages is included in reading target data, as described with reference to FIG. 14, the page-over logical-physical conversion processing circuit 331 of the command management circuit 33 calculates MCOs (xMCO) corresponding to an LCA spanning the pages on the basis of the transferred MCO (step ST75).

In addition, the command management circuit 33 refers to the logical-physical conversion table T2 in the RAM 2 and performs a logical-physical conversion process on the MCO and the obtained xMCO (step ST76). Thereby, an NBA indicating a physical address corresponding to the reading target data which is stored in the flash memory is obtained from the LCA, the MCO, and the xMCO.

A reading command is issued from the command management circuit 33 to the memory controller 30 (step ST77).

The data which is stored in a page indicated by the obtained NBA is read to the memory controller 30 (step ST78).

The data which is read from the page of the flash memory indicated by the NBA is transferred from the memory controller 30 to the data reading control circuit 32 (step ST79).

The data requested by the host is transferred from the data reading control circuit 32 to the host 9.

As described above, data is read from the memory of the storage device of the exemplary embodiment.

Through the operation of the storage device of the exemplary embodiment, it is possible to rapidly calculate a leading address of a page (physical address) from a logical cluster offset (logical address) regardless of a difference in a total number of clusters which can be stored.

For this reason, according to the storage device of the exemplary embodiment, a cache hit when a reading operation of the memory is performed is rapidly determined. As a result, according to the exemplary embodiment, reading operation characteristics of the storage device can be improved.

### (2) Modified Examples

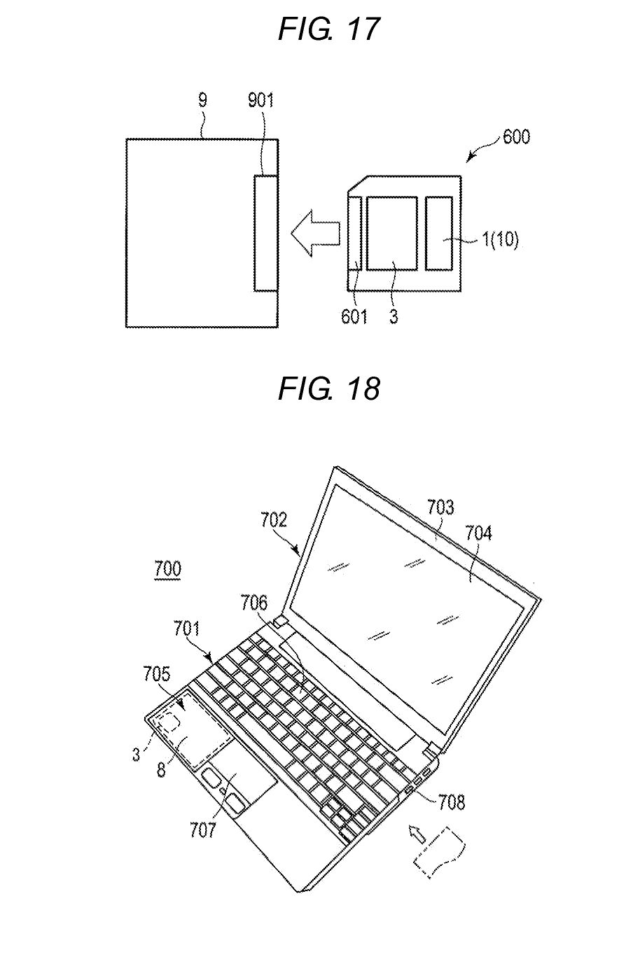

Modified examples of the storage device including the controller described in the exemplary embodiment will be described with reference to FIG. 17.

FIG. 17 is a schematic diagram illustrating one of the modified examples of the storage device including the controller described in the exemplary embodiment. In the above-described exemplary embodiment, the SSD is exemplified as the storage device. However, the storage device may be a memory card (memory system).

As shown in FIG. 17, a memory card 600 provided with the controller 3 of the exemplary embodiment includes the controller 3, one or more flash memories 1 (10), and an interface 601 having a plurality of connectors.

The memory card 600 is formed so as to be insertable into or removable from a slot 901 which is provided in the host 9 or an external device (for example, a PC, a portable terminal, or a digital camera) including the host 9. The memory card 600 including the controller 3 of the exemplary embodiment is connected to the host 9 via the connector 601. In addition, the memory card 600 may be connected to the host 9 such that data communication can be performed through wireless communication (noncontact communication).

The controller 3 described in the exemplary embodiment is used for the memory card 600, and thereby it is possible to improve operation characteristics when data reading of the memory card is performed. In addition, the controller 3 described in the exemplary embodiment is used for the memory card 600, and thereby it is possible to suppress an increase in a size of the address conversion and management tables between the host and the memory and to thereby reduce a storage capacity of the RAM.

In addition, the controller 3 of the exemplary embodiment may be used for a USB memory, or a storage device (memory system) based on a standard such as an embedded MultiMedia Card (eMMC) standard or a Universal Flash Storage (UFS) standard.

### (3) Application Examples

Application examples of the storage device including the controller of the exemplary embodiment will be described with reference to FIGS. 18 to 20.

FIGS. 18 to 20 are schematic diagrams illustrating several application examples of the storage device of the exemplary embodiment.

FIG. 18 is a perspective view illustrating an example of the personal computer in which the storage device (for example, an SSD) 8 of the exemplary embodiment is mounted.

As shown in FIG. 18, a personal computer 700 includes a main body 701 and a display unit 702. The display unit 702 includes a display housing 703 and a display device 704 accommodated in the display housing 703.

The main body 701 includes a casing 705, a keyboard 706, and a touch pad 707 which is a pointing device. A main circuit board, an Optical Disk Device (ODD) unit, a card slot, and the SSD 8 are accommodated in the casing 705.

The card slot is provided so as to be adjacent to a peripheral wall of the casing 705. An opening 708 opposite to the card slot is provided in the peripheral wall. A user can insert and remove an additional device into and from the card slot from outside of the casing 705 via the opening 708.

The SSD 8 may be used in a state of being mounted inside the personal computer 700 as a substituent of a hard disk drive (HDD) in the related art, or may be used as an additional device in a state of being inserted into the card slot of the personal computer 700.

The SSD 8 of the personal computer 700 includes the controller 3 described in the exemplary embodiment.

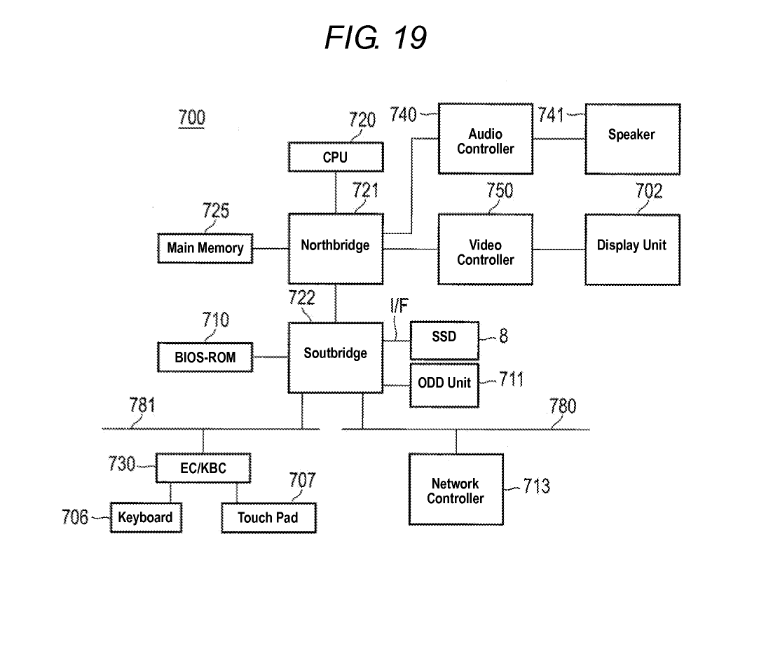

FIG. 19 is a block diagram illustrating a configuration example of the personal computer in which the storage device (for example, an SSD) of the exemplary embodiment is mounted.

As shown in FIG. 19, the personal computer 700 includes a CPU 720, a northbridge 721, a main memory 725, a video controller 750, an audio controller 740, a southbridge 722, BIOS-ROM 710, the SSD 8, an ODD unit 711, an embedded controller/keyboard controller (EC/KBC) 730, a network controller 713, and the like.

The CPU 720 is a processor which is provided so as to control an operation of the personal computer 700. The CPU 720 executes an operating system (OS) loaded to the main memory 725 from the SSD 8. In addition, if the ODD unit 711 makes at least one process of a reading process and a writing process for a seated optical disc capable of being performed, the CPU 720 performs the process.

In addition, the CPU 720 also executes a Basic Input Output System (BIOS) stored in the BIOS-ROM 710. Further, the BIOS is a program for controlling hardware of the personal computer 700.

The northbridge 721 is a bridge device which connects a local bus of the CPU 720 to the southbridge 722. A memory controller which controls access to the main memory 725 is embedded in the northbridge 721.

In addition, the northbridge 721 also has a function of communicating with the video controller 750 and the audio controller 740 via an Accelerated Graphics Port (AGP) bus or the like.

The main memory 725 temporarily stores a program or data, and functions as a work area of the CPU 720. The main memory 725 includes, for example, a RAM.

The video controller 750 is a video reproduction controller which controls the display unit 702 used as a display monitor of the personal computer 700.

The audio controller 740 is an audio reproduction controller which controls a speaker 741 of the personal computer 700.

The southbridge 722 controls each device on a Low Pin Count (LPC) bus 781 and each device on a Peripheral Component Interconnect (PCI) bus 780. In addition, the southbridge 722 controls an operation of the SSD 8 which is a storage device storing a variety of software and data via an interface I/F such as SAS or SATA. In addition, the southbridge 722 also has a function of controlling access to the BIOS-ROM 710 and the ODD unit 711.

The personal computer 700 accesses the SSD 8 with the cluster unit or the sector unit. A write command, a read command, a cache flash command, and the like are input to the SSD 8 via the interface I/F.

The EC/KBC 730 is a one-chip microcomputer into which an embedded controller for managing power and a keyboard controller for controlling a keyboard (KB) 706 and a touch pad 707 are integrated.

The EC/KBC 730 has a function of powering ON and OFF the personal computer 700 in response to a power button operation by a user. The network controller 713 is a communication device which communicates with an external network such as, for example, the Internet.

Configurations and operations of the SSD 8 applied to the computer and the controller 3 included therein are the same as in the above-described exemplary embodiment.

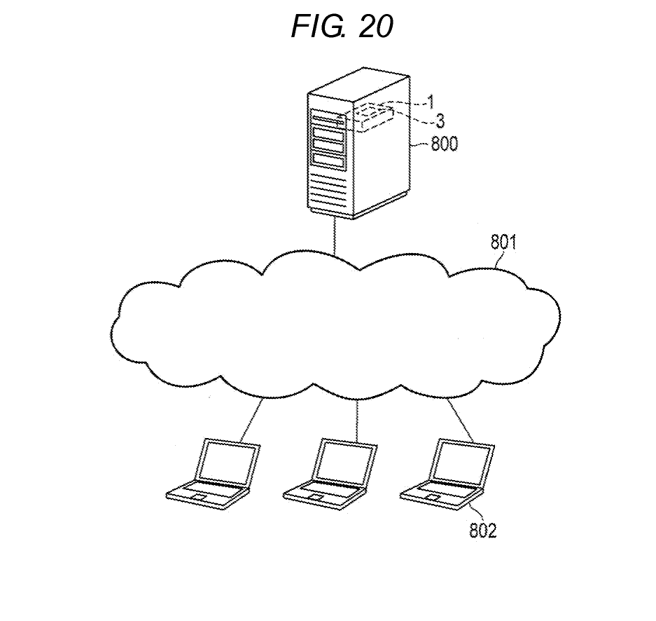

FIG. 20 is a conceptual diagram illustrating an application example of a server in which the storage device of the exemplary embodiment is mounted.

As shown in FIG. 20, a server 800 is connected to Internet 801. The SSD 8 of the exemplary embodiment is mounted in the server 800. In addition, a terminal, for example, a computer 802 is connected to the Internet (for example, a network using cloud computing) 801. A user accesses the SSD 8 of the server 800 from the computer 802 via the Internet 801.

The SSD 8 of the server 800 includes the controller 3 of the above-described exemplary embodiment.

Configurations and operations of the SSD 8 applied to the server 800 and the controller 3 included therein are the same as in the above-described exemplary embodiment.

The storage device 8 of the exemplary embodiment and the controller 3 included in the storage device 8 are applied to the personal computer or the server, and thereby it is possible to improve operation characteristics when data reading is performed. The storage device 8 of the exemplary embodiment and the controller 3 included in the storage device 8 are applied to the personal computer or the server, and thereby it is possible to suppress an increase in a size of the address conversion and management tables between the host and the memory and to thereby reduce a storage capacity of the RAM.

Others

Although, in the exemplary embodiment, a NAND type flash memory is exemplified as a nonvolatile memory used for the first memory, the invention is not limited thereto. Flash memories (for example, a NOR type flash memory) other than the NAND type flash memory or an MRAM, a ReRAM, or a PCRAM may be used as the first memory. In addition, the flash memory may be a flash memory (for example, a BiCS memory) with a three-dimensional structure in which a plurality of memory cells are arranged in a direction parallel to a surface of a semiconductor substrate and a plurality of memory cells are laminated in a direction perpendicular to the substrate surface.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a memory including one or more storage regions each of which is assigned a physical address; and
a controller that includes a writing control circuit configured to write data that is divided into a plurality of data units into logical storage positions, at least one of which is associated with two storage regions of the memory, and a conversion unit configured to perform a conversion process on a logical address of the logical storage position that is associated with two storage regions of the memory to generate physical addresses corresponding to the two storage regions of the memory.

2. The device according to claim 1, wherein the two storage regions of the memory includes a first storage region and a second storage region, and the conversion process includes a first conversion process to convert the logical address to a first logical offset and a second logical offset and a second conversion process to convert the first logical offset to a first physical address corresponding to the first storage region and the second logical offset to a second physical address corresponding to the second storage region.

3. The device according to claim 2, wherein the first conversion process is performed using a first table that associates logical addresses to logical offsets, and the second conversion process is performed using a second table that associates logical offsets to physical addresses.

4. The device according to claim 3, wherein the first table stores the first logical offset and does not store the second logical offset.

5. The device according to claim 4, wherein the second logical offset is the first logical offset plus a single incrementing value if there are no unused storage positions between the storage position associated with the first logical offset and the storage position associated with the second logical offset.

6. The device according to claim 5, wherein the second logical offset is the first logical offset plus a double incrementing value if there is one unused storage position between the storage position associated with the first logical offset and the storage position associated with the second logical offset.

7. The device according to claim 4, wherein the first table is generated based on a maximum number of logical offsets per page and storage positions of unused logical offsets.

8. The device according to claim 1, wherein the memory is a flash memory, and the physical addresses are pages of the flash memory.

9. A controller comprising:
a first control unit that creates a management table in which logical addresses are associated with logical offsets in a one-to-one relationship; and
a second control unit that converts a single logical address to two logical offsets and generates a command to write a data unit associated with the single logical address into two physical addresses of a memory associated with the two logical offsets.

10. The controller according to claim 9, wherein the second control unit further converts the two logical offsets into the two physical addresses using a table stored in volatile memory that associates logical offsets to physical addresses.

11. The controller according to claim 9, wherein the two logical offsets include first and second logical offsets and the second logical offset is the first logical offset plus a single incrementing value if there are no unused storage positions between the storage position associated with the first logical offset and the storage position associated with the second logical offset.

12. The controller according to claim 11, wherein the second logical offset is the first logical offset plus a double incrementing value if there is one unused storage position between the storage position associated with the first logical offset and the storage position associated with the second logical offset.

13. The controller according to claim 9, wherein the management table is created based on a maximum number of logical offsets per page and storage positions of unused logical offsets.

14. The controller according to claim 9, wherein the memory is a flash memory, and the physical addresses are pages of the flash memory.

15. A method of writing data to a memory including one or more storage regions each of which is assigned a physical address, said method comprising:
converting a logical address of a data unit to be written into a first logical offset and a second logical offset;
converting the first logical offset into a first physical address and the second logical offset into a second physical address; and
generating a write command to write the data unit to the first and second physical addresses.

16. The method of claim 15, wherein the logical address is converted using a first table that associates logical addresses to logical offsets, and the logical offsets are converted using a second table that associates logical offsets to physical addresses.

17. The method of claim 16, wherein the first table stores the first logical offset and does not store the second logical offset.

18. The method of claim 17, wherein the second logical offset is the first logical offset plus a single incrementing value if there are no unused storage positions between the storage position associated with the first logical offset and the storage position associated with the second logical offset.

19. The method of claim 18, wherein the second logical offset is the first logical offset plus a double incrementing value if there is one unused storage position between the storage position associated with the first logical offset and the storage position associated with the second logical offset.

20. The device according to claim 16, wherein the first table is generated based on a maximum number of logical offsets per page and storage positions of unused logical offsets.
